(19) United States
(12) Patent Application Publication
(10) Pub. No.: US 2006/0164707 A1
(43) Pub. Date: Jul. 27, 2006

(54) Image forming apparatus

(75) Inventors: Takayuki Kurihara, Osaka (JP); Hideki Sugimura, Osaka (JP); Hideki Okamura, Osaka (JP)

Correspondence Address: ROSSI, KIMMS & McDOWELL LLP., P.O. BOX 826, ASHBURN, VA, 20146-0826, US

(73) Assignee: Kyocera Mita Corporation, Chuo-ku (JP)

(21) Appl. No.: 11/318,029

(22) Filed: Dec. 23, 2005

(30) Foreign Application Priority Data
Dec. 28, 2004 (JP) 2004-380293

(51) Int. Cl. G02B 26/08

(52) U.S. Cl. 359/204; 359/216

(57) ABSTRACT

The scanning optical system, wherein a plurality of light beams are scanned by only single rotational polygon mirror, and which is simpler, cheaper, due to fewer components, is provided for the image forming apparatus. Axes of a plurality of beam collimators are separated at prescribed pitches with light beam axes, thereby making the light beams incident at different positions at the reflecting surface of the polygonal mirror along the sub-scanning direction. As a result, the light beams are incident at different angles to the rotational polygonal mirror, deflected by the mirror surface, and largely spread from the optical axis of the optical system.

### BACKGROUND OF THE INVENTION

(1) Field of the Invention

The present invention relates to electro-photographic image forming apparatus such as a copier, printer, facsimile and a hybrid apparatus thereof, particularly to a tandem color image forming apparatus wherein photoreceptors for yellow (Y), cyan (C), magenta (M) and black (B) are positioned in series along a paper path and are exposed by a modulated laser beam which carries each color image information and is scanned by a rotating polygonal mirror.

(2) Description of the Related Art

There are several types of an exposing apparatus for the photoreceptor in the electro-photographic image forming apparatus such as the copier, facsimile and the hybrid apparatus thereof. One of them is, as shown in FIG. 5, a light beam scanner wherein the rotating polygonal mirror 31 deflects by a reflecting surface 32 a light beam 36 from a light source 30. Other type is a selfoc lens with an LED array. Here, scanning lenses 33₁ and 33₂ scan the light beam 36 reflected by the reflecting surface 32 of the rotating polygonal mirror 31, on the photoreceptor 34, at about constant speed along the axis of the photoreceptor 34. Further, an optical axis 35 is shown. FIG. 6 shows an outline of an optical system in the scanning apparatus employing the rotating polygonal mirror 31. There are shown In FIG. 6, the light source 30 the reflecting surface 32 of the rotating polygonal mirror 31, the scanning lens 33, i.e., the scanning lenses 33₁ and 33₂ as shown in FIG. 5, the photoreceptor 34, the optical axis 35 of the optical system, the light beam 36 from the light source 30, a collimator lens 41, an aperture 42, a cylindrical lens 43. For the simplicity of explanation, an optical path from the light source to the reflecting surface 32 of the rotating polygonal mirror 31 and an optical path from the reflecting surface 32 to the photoreceptor 34 are linearly aligned. The light beam 36 from the light source 30 such as the laser diode is modulated by an image signal, is made parallel by the collimator lens 41, is limited by the aperture 42, and is focused by the cylindrical lens 43 onto the reflecting surface 32 of the rotating polygonal mirror 31. Further, the light beam 36 is deflected by the reflecting surface 32 of the rotating polygonal mirror 31 and is scanned by the scanning lens 33, on the photoreceptor, at the nearly constant speed along the axis of the photoreceptor. Further, curvature centers of the optical surfaces of the collimator lens 41 and the cylindrical lens 43 is positioned at the optical axis of the optical system. Further, the reflecting surface 32 is positioned at the back focus position of the cylindrical lens 43. Further, the scanning lens 33 is positioned in such a manner that the reflecting surface 32 of the scanning mirror 31 is conjugate with the surface of the photo-receptor 34, thereby suppressing a bad effect by a small tilt of the reflecting surface 32 of the scanning mirror 31. The scanning apparatus is employed in a relatively high speed and a relatively costly image forming apparatus. The height of the polygonal mirror is made about, e.g., 2 mm, for a cost reduction and for speeding up a start-up of a driving motor.

The rotating polygonal mirror or the LED array is employed in a high speed or low speed personal use tandem color image forming apparatus, respectively, wherein the photoreceptors for yellow (Y), cyan (C), magenta (M) and black (B) are positioned in series along the paper path, the photoreceptors being exposed by the modulated laser beam which carries each color image information and is scanned by the rotating polygonal mirror, the photo-receptors being developed by each color toner and the toner images are transferred onto a paper.

However, the optical path is relatively long in the rotating polygonal mirror optical system, thereby making the tandem color image forming apparatus large-sized and costly, because the polygonal mirror is required for each color. Therefore, it is being proposed that a plurality of light beams are deflected by a single polygonal mirror and are separated by a mirror for each photo-receptors, as shown in FIG. 7.

Reflecting mirrors 9₁, 9₂, 9₃, 9₄, 10₁, 10₂, 10₃ are provided in accordance with the photoreceptors 10₁, 10₂, 10₃, 10₄ positioned along the paper path. They introduce the light beams 55₁, 55₂, 55₃, 55₄ from the light sources 51₁, 51₂, 51₃, 51₄, respectively, to the photoreceptors 11₁, 11₂, 11₃, 11₄, respectively. The light beams 55₁, 55₂, 55₃, 55₄ are made parallel by the collimator lenses 52₁, 52₂, 52₃, 52₄, respectively, and is limited by the apertures 53₁, 53₂, 53₃, 53₄, respectively, and finally focused on the reflecting surface 57 of the rotating polygonal mirrors. The light beams 55₁, 55₂, 55₃, 55₄ are deflected by the reflecting surface 57, passes the scanning lens 58, are separated by the reflecting mirrors 9₁, 9₂, 9₃, 9₄, thereby scanning the photoreceptors 11₁, 11₂, 11₃, 11₄. There is shown in FIG. 5 the optical axis 56.

FIG. 8 is a partial extended view of a portion wherein the light beams 55₁, 55₂, 55₃, 55₄ incident in the cylindrical lens 54, in parallel with the optical axis 56. They are focused on the reflecting surface 57 of the rotational polygonal mirrors.

However, when the light beams 55₁, 55₂, 55₃, 55₄ reflected by the reflecting surface 57 of the polygonal mirrors are incident in the reflecting mirrors 9₁, 9₂, 9₃, 9₄, respectively, the light beams 55₁, 55₂, 55₃, 55₄ should be separated in some degree along the normal direction of the photoreceptor axis. There are several ways to increase the beam separations. The first way is to increase the distance between the scanning lens and the reflecting mirrors 9₁, 9₂, 9₃, 9₄. The second way is to disperse the light beams 55₁, 55₂, 55₃, 55₄ by increasing the optical power of the scanning lens 58. The third way is to increase the width of the cylindrical lens 54 along the sub-scanning direction (normal direction to the photoreceptor axis, thereby increasing the incident angles to the reflecting surface 57 of the polygonal mirrors.

However, the first way inevitably makes the image forming apparatus large-sized. The second way makes the beam radiuses enlarged. As a result, a short focus lens is required, thereby shortening the focal depth in an impractical degree. The third way makes the cylindrical lens 54 large-sized and costly.

An example of tandem color image forming apparatus with a single rotational polygonal mirror for the multi-beams is disclosed in JP8-271817A (1996) as shown in FIG. 9.

In an optical system 100 as shown in FIG.9, there are incident in a mirror surface of the rotating polygonal mirror 101 a four light beams LK, LY, LM, LC from the not-shown laser diodes. Each beam is separated linearly along the rotational axis O direction (the sub-scanning direction). Further, each beam is crossed with each other at a position P on a plane Q normal to the rotational axis O. The light beams LK, LY, LM, LC deflected by the mirror surface of the rotational polygonal mirror 101 approach the position P, approach the surface Q, pass the troidal lens 102, cross with each other at the position P, separate with each other, pass the f θ lens 103, are deflected by the folding mirrors 104aK˜104cK, 104aY˜104cY, 104aM˜104cM, 104aC˜104cC, respectively in such a manner that their optical path lengths are equal. After the deflection, they pass dust proof glasses 105K, 105Y, 105M, 105C, respectively, expose and scan the photoreceptor drum along the main scanning direction (the photoreceptor axis), thereby forming the electrostatic latent images.

However, the scanning optical system 100 disclosed in JP8-271817A(1996) has a disadvantage that the light beams LK, LY, LM, LC after passing the fO lens 103 are separated only a little along the sub-scanning direction, because they cross with each other just in front of the position P.

The light beams LK, LY, LM, LC should be surely separated with each other, before they reach the photoreceptors 106K, 106Y, 106LM, 106LC. Otherwise, the photoreceptors are not sufficiently exposed and the latent images become noisy. Although it is reasonable that the light beams are separated by the folding mirrors 104aK, 104aY, 104aM, 104aC, the folding mirrors can hardly be positioned very near the crossing position P. This is because the folding mirrors disclosed in JP8-271817A(1996) are separated only a little along the sub-scanning direction.

If the folding mirrors 104aK, 104aY, 104aM, 104aC are positioned at a far position from the point P, the apparatus becomes large-sized, in spite of the reduction of number of the scanning mirrors and scanning lenses, because the optical path length become longer.

A special lens such as a toric lens for separating the light beams LK, LY, LM, LC may be positioned near the position P. However, the folding mirrors 104aK, 104aY, 104aM, 104aC mealy come near the position P and the distance between the rotational polygon mirror and the point P cannot be shortened. Accordingly, the apparatus is still costly.

Therefore, it is not preferable to lengthen the optical path length from the mirror surface or to employ the special lens. There is disclosed in JP11-119131A(1999) a scanning optical system wherein the deflected light beams can be separated in a short distance. In the scanning optical system as disclosed in JP11-119131A(1999), a plurality of light beams incident to the reflecting surface of the rotational polygon mirror are crossed with each other at the light source sides from the reflecting surface, as shown in FIG. 10 and FIG. 11.

FIG. 10 is a side view of the scanning optical system, the rotational polygonal mirror 85 being shown in the center of the figure. FIG. 11A is a side view of an optical system from the light sources 81K, 81Y such as laser diodes to the rotational polygon mirror 85. FIG. 11B is a side view of the optical system from the rotational polygon mirror to the photoreceptor 91K, 91Y, 91M, 91C.

The following parts are symmetrically positioned in a plane normal to the paper path: four laser diodes 81K,81Y, 81M and 81C (only 81K and 81Y are shown in FIG. 11A and FIG. 11B); scanning mirrors 86a , 86b and so on each of which comprises a troidal lens and a f θ lens; folding mirrors 87aK 87cK, 87aY˜87cY, 87aM˜87cM, 87aC˜87cC; second cylindrical lenses 98K, 89Y, 89M, 89C which correspond to photoreceptors 91K, 91Y, 91M, 91C, respectively; and the rotational polygon mirror 85 in the center.

The light beams LK and LY pass the collimator lenses 82K and 82Y in order to make parallel beams), pass the first cylindrical lenses 83K and 83Y(which are independent, although they are overlapped in FIG. 11A), are focused only along the rotational axis direction, reflected by the reflection mirrors 84K and 84Y, are crossed with each other at the position P and are arranged in line along the rotational axis O at the reflection surface of the rotational polygon mirror 85.

The light beams LK and LY pass the collimator lenses 82K and 82Y in order to make parallel beams), pass the first cylindrical lenses 83K and 83Y(which are independent, although they are overlapped in FIG. 11A), are focused only along the rotational axis direction, reflected by the reflection mirrors 84K and 84Y, are crossed with each other at the position P and are arranged in line along the rotational axis O at the reflection surface of the rotational polygon mirror 85.

The light beams LM and LC from the laser diodes 81M and 81C which are arranged at the opposite side of the rotational polygon mirror 85 are incident to the opposite side reflecting surface. Thus, two light beams are incident from the upper stream and two light beams are incident from the lower stream. The incident angles of the light beams LK, LY, LM and LC are such that the light beams are crossed with each other at the point P (cf. FIG. 11A) in front of the mirror surface to the light sources sides on the plane Q normal to the rotational axis and the light beams are arranged in line at the mirror surface along the rotational axis direction (sub-scanning direction).

As shown in FIG. 11B, the deflected beams LK and LY go away from the reflecting surface of the rotational polygonal mirror 85, are separated, pass the troidal lens and f θ lens. The light beams LK and LY are focused along the main-scanning direction at a constant scanning speed and are made parallel along the sub-scanning direction. The light beams LK and LY pass the scanning lens 86a, change the optical path in such a manner that their optical path lengths are made equal by the folding mirrors 87aK˜87cK and 87aY˜87cY, pass the second cylindrical lenses 89K and 89Y which focus the light beams only along the sub-scanning direction, scan and expose along the main-scanning direction the photoreceptors 91K and 91Y, thereby forming the electrostatic latent images.

However, the apparatus as disclosed in JP11-119131A(1999) is large-sized, because two optical systems opposite with each other surrounding the rotational polygon mirror 85 and the apparatus is costly due to increase in the number of the parts such as the four cylindrical lenses 83K, 83Y, 83M and 83C and two sets of the focusing lenses 86a and 86b.

The apparatus as disclosed in JP11-119131A(1999) has another disadvantage that the laser diodes 81K and 81Y, collimator lens 82K and 82Y can hardly united, because its shape become complex and its accuracy can hardly guaranteed, because the optical system from the light sources to the rotational polygon mirror 85 is inclined as a whole.

If the supporting member for the laser diodes 81K and 81Y are independent, the area occupied by the light source portion become large and the apparatus become large-sized. Further, no matter whether they are unified or separated, an adjustment jig can hardly be designed, because the collimator lenses 82K and 82Y moves in different directions during a beam spot adjustment.

Further, the positions of the collimator lenses 82K and 82Y should be adjusted in planes normal to its optical axes in order to fix the output angle of the light beams from the light sources 82K and 82Y. Those adjustment planes are different, depending upon the optical paths. Accordingly, The structure of the light source support member becomes complex, its accuracy is lowered and the adjustment jig can be hardly designed.

### SUMMARY OF THE INVENTION

An object of the present invention is to provide a simper and cheaper optical system for a rotational polygon mirror scanning system, wherein a plurality of light beams for forming a color image are scanned by a single rotational polygon mirror by using fewer components.

The electro-photographic color image forming apparatus of the present invention is an apparatus wherein a single rotational polygonal mirror scans a plurality of light beams for exposing the plurality of photoreceptors.

The apparatus of the present invention comprises: collimator lenses for making the light beams parallel; and an intermediate lens, positioned between the collimator lenses and the rotational polygonal mirror, for focusing the light beams on a reflecting surface of the rotating polygonal mirror.

In the apparatus of the present invention, optical axes of light sources of the light beams are parallel to axes of the collimator lenses; the optical axes of light sources of the light beams are separated by prescribed pitches from the axes of the collimator lenses; the light beams are incident to the intermediate lens at different incident positions along sub-scanning directions of the photoreceptors; and the light beams are incident to the intermediate lens at different angles.

Here, the incident angles are greater as the incident positions are more separated from the optical axes of the intermediate lens which is a single cylindrical lens.

Further, the apparatus of the present invention comprises a scanning lens for focusing on the photoreceptors the light beams deflected by the rotational polygon mirror and for scanning on the photoreceptors at constant speed on the photoreceptors along main-scanning directions of the photoreceptors.

Further, the light beams expose the photoreceptors allocated to electrostatic latent images of yellow, cyan, magenta and black.

According to the present invention, the scanning optical system, wherein a plurality of light beams are scanned by only single rotational polygon mirror, and which is simpler, cheaper, due to fewer components, can be provided for the image forming apparatus.

### BRIEF DESCRIPTION OF THE DRAWINGS

FIG. 1 is a schematic plan view of a tandem color image forming apparatus with a scanning apparatus of the present invention.

FIG. 2 is a side view of the optical system. The optical path from the light source to the rotational polygon mirror and the optical path from the polygon mirror to the photoreceptor is aligned in a straight line for simplicity of explanation.

FIG. 3 shows an optical path from the light source to the rotational polygon mirror.

FIG. 4 shows an optical path from the light source to the cylindrical lens.

FIG. 5 is a schematic view of the scanning system with the rotational polygon mirror.

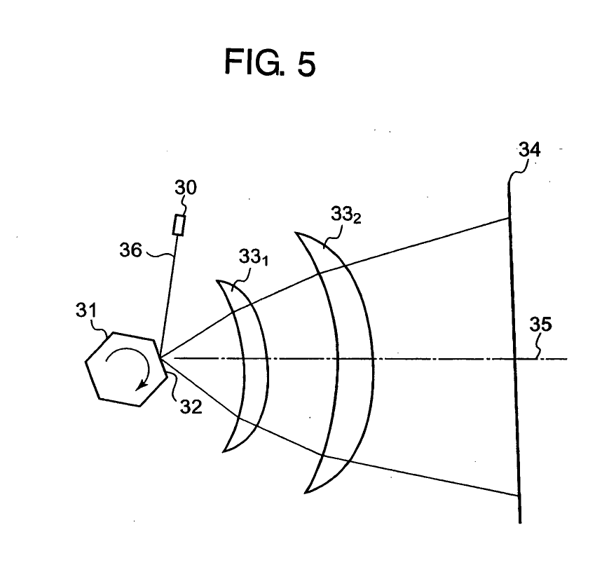

FIG. 6 is a schematic view of the optical system of the scanning system with the rotational polygon mirror.

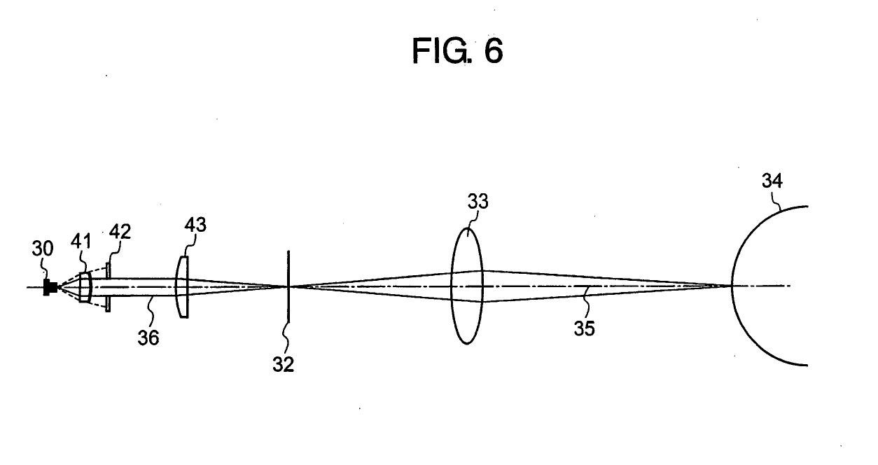

FIG. 7 is a schematic view of an image forming apparatus with a single rotational polygon mirror for a plurality of the light beams.

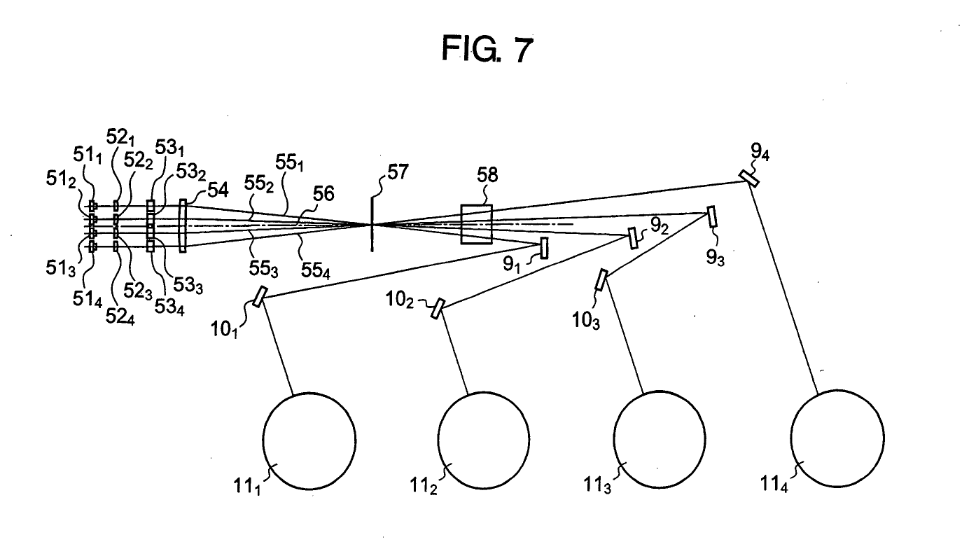

FIG. 8 is an enlarged view of the cylindrical lenses to which a plurality of the light beams are incident.

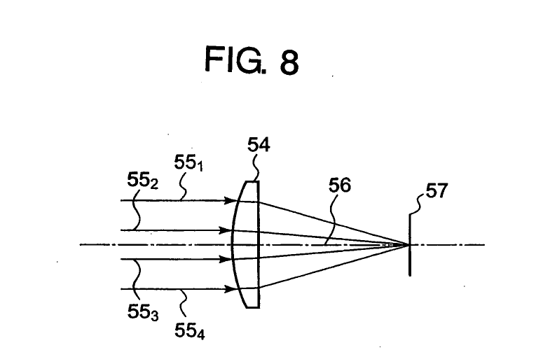

FIG. 9 is a schematic view of a tandem color image forming apparatus with a single rotational polygon mirror for a plurality of the light beams.

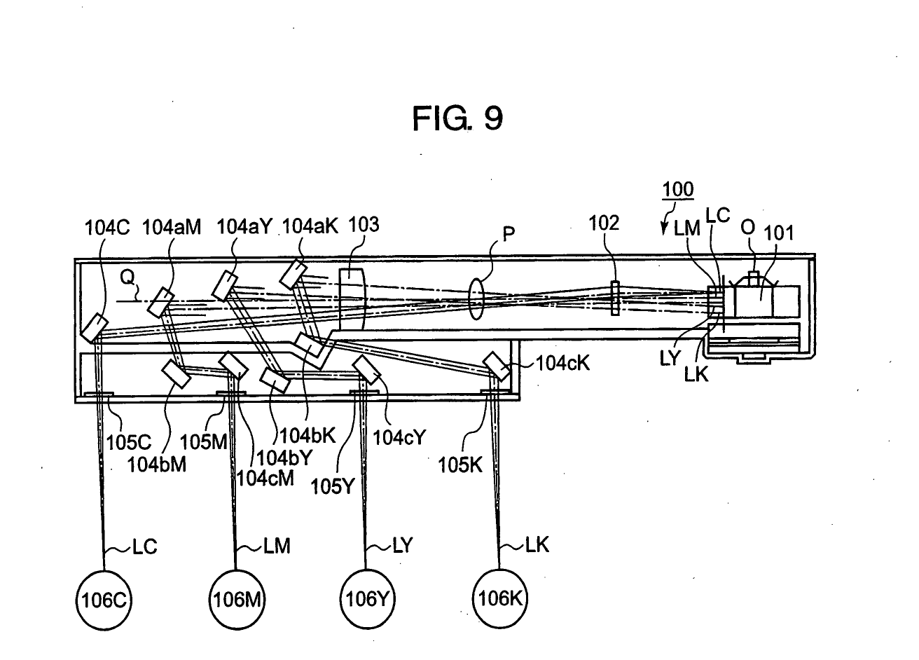

FIG. 10 is a side view of the scanning optical system as disclosed in JP11-119131A (1999).

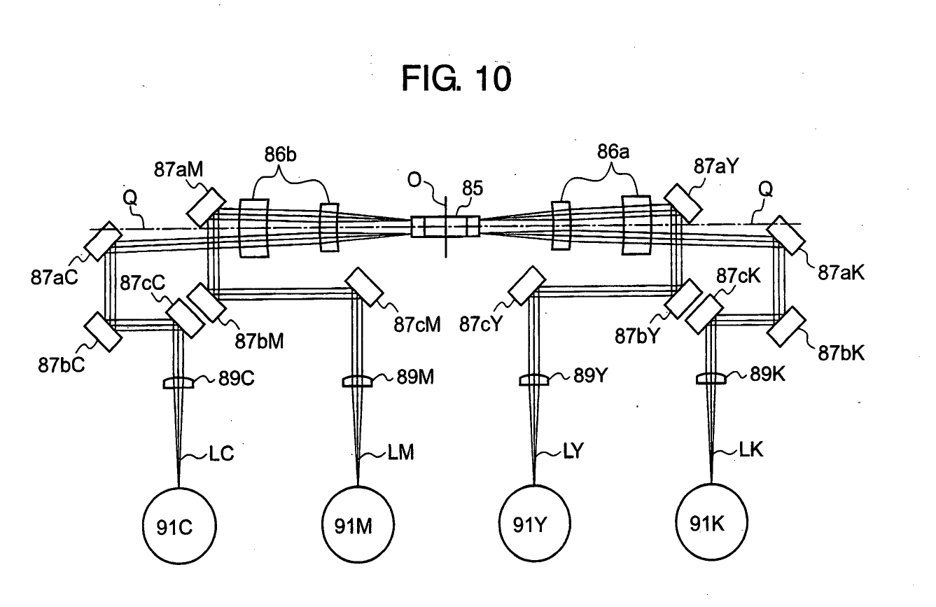

FIG. 11A is a side view of a partial optical system from the light source to the rotational polygon mirror, while FIG. 11B is a side view of a partial optical system from the rotational polygon mirror to the photoreceptor.

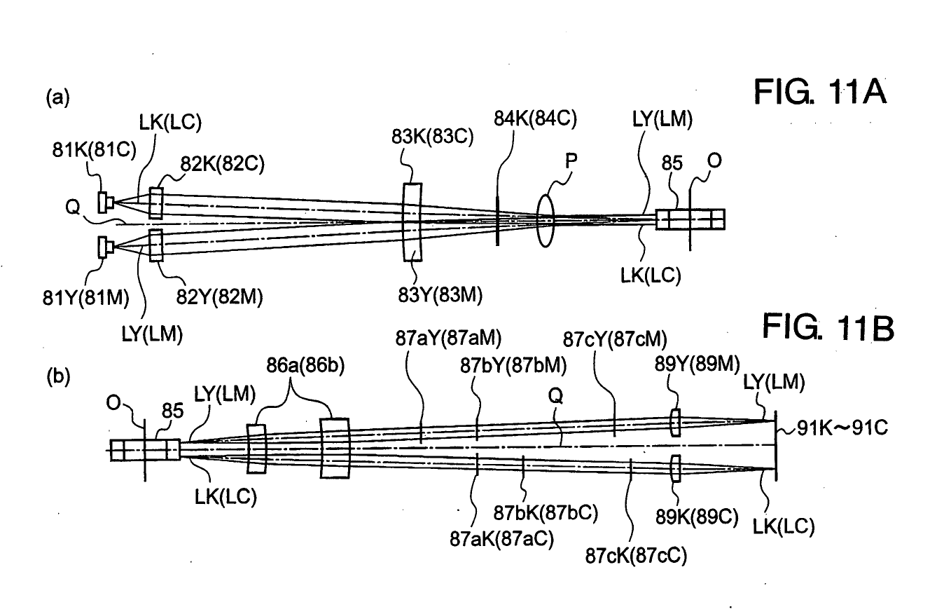

### DETAILED DESCRIPTION OF THE PREFERRED EMBODIMENTS

Preferred embodiments of the present invention are explained, referring to the drawings. It is understood that the present invention is not limited to specific descriptions concerning sizes, materials, shapes and relative arrangements of components.

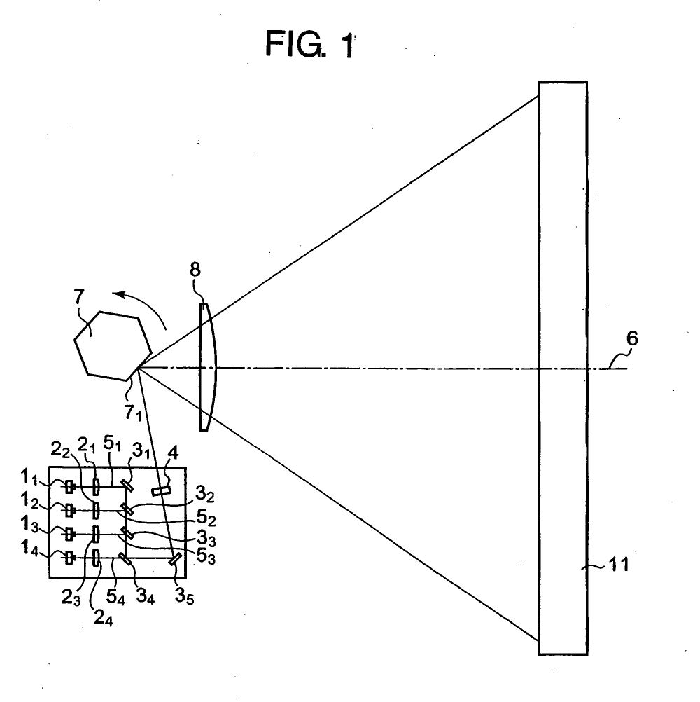

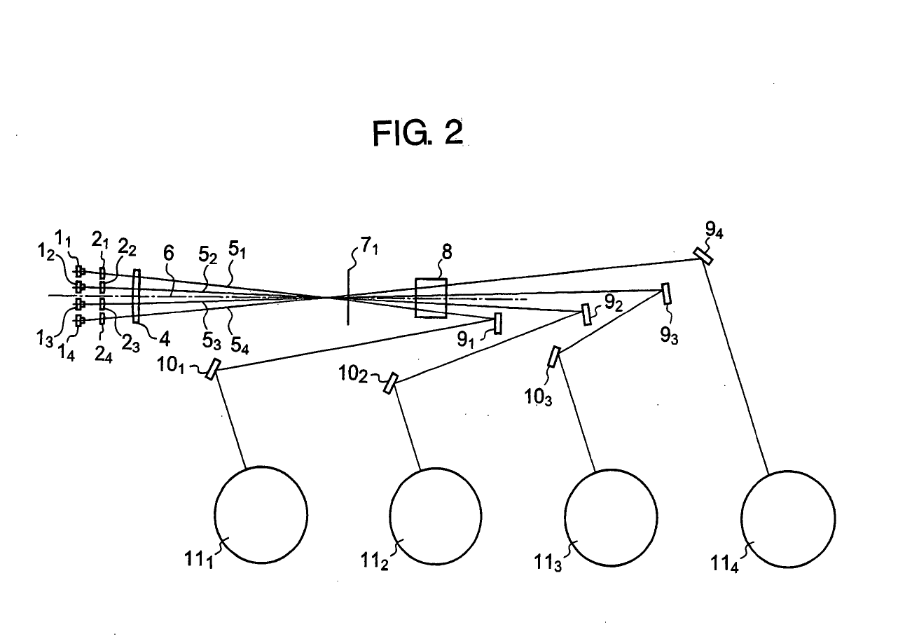

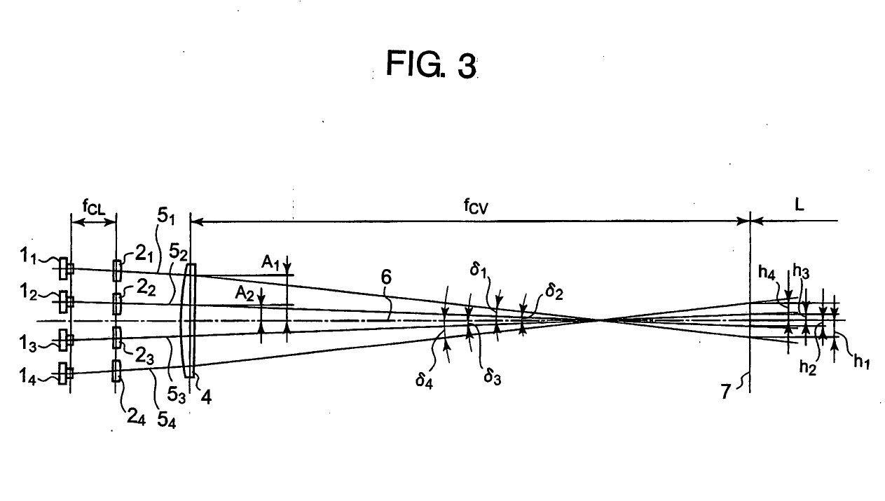

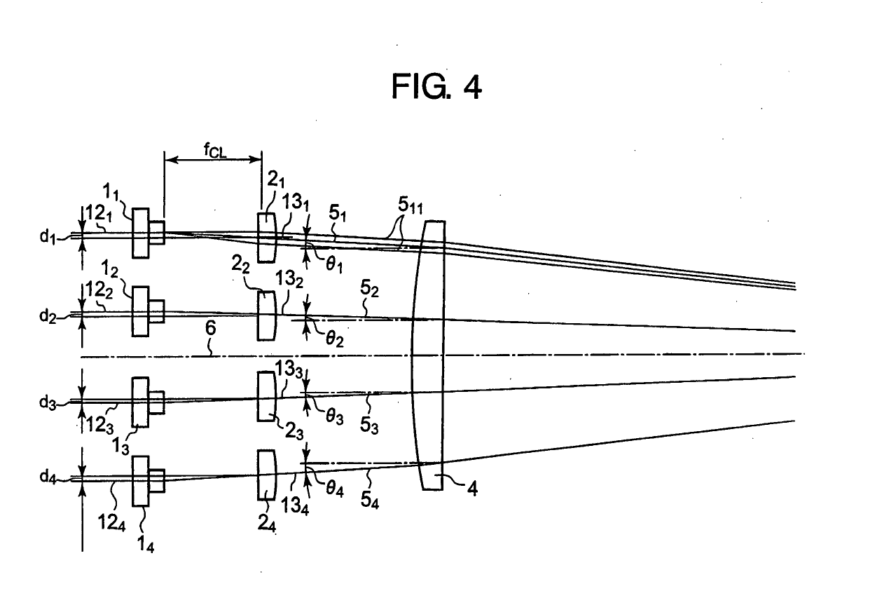

FIG. 1 is a schematic plan view of a tandem color image forming apparatus with a scanning apparatus of the present invention. FIG. 2 is a side view of the optical system. The optical path from the light source to the rotational polygon mirror and the optical path from the polygon mirror to the photoreceptor is aligned in a straight line for simplicity of explanation. FIG. 3 shows an optical path from the light source to the rotational polygon mirror. FIG. 4 shows an optical path from the light source to the cylindrical lens.

The light beams 5₁˜5₄ from the light sources 1₁˜1₄ such as laser diodes are modulated by the image signals corresponding to yellow (Y), cyan (C), magenta (M), black (K). Further, there are provided in the optical system the collimator lens 2₁˜2₄ for making the light beams parallel, the reflecting mirror 3₁˜3₅ for making the light beams incident to the reflecting surface 7₁ of the rotational polygon mirror 7, the ordinary mirrors 3₁ and 3₅ the half mirror 3₂˜3₄ and the cylindrical lens or aspherical lens 4.

The light beams are reflected by the reflecting surface 7₁ of the rotational polygon mirror 7 and are focused by the f θlens 8 k scanned at an about constant along the main-scanning direction of the photoreceptors 11₁˜11₄. The first reflecting mirrors 9₁ and 9₅ direct the light beams outputted from the scanning lens 8 to the photoreceptors 11₁˜11₄ corresponding to Y,M,C and B. The second reflecting mirrors 10₁ and 10₄ direct the light beams reflected by the first mirrors to the photoreceptors 11₁˜11₄. There are shown the optical axis 6 of the optical system, the optical axes 12₁˜12₄ of the light sources 1₁˜1₄ and the optical axes 13₁˜13₄ of the collimator lenses 2₁˜2₄.

Although the following elements are not shown, there are provided surrounding the photoreceptors 11₁˜11₄ charging apparatuses, development apparatuses, cleaning apparatuses, transfer apparatuses, each of which being an ordinary electro-photographic process member.

As shown in FIG. 1 and FIG. 2, the optical system which makes the light beams incident to the reflecting surface 7₁ of the rotating polygonal mirror 8 in the scanning apparatus used in the image forming apparatus comprises the light sources 1₁˜1₄, the collimator lenses 2₁˜2₄, the half mirror 3₁˜3₄. As shown in FIG. 3 and FIG.4, the light beams 5₁˜5₄ are incident at different positions of the cylindrical lens or aspherical lens 4 along the sub-scanning direction at different incident angles θ₁˜θ₄. Further, as shown in detail in FIG. 4, the optical axes 12₁˜12₄of the light sources 1₁˜1₄ and the optical axes 13₁˜13₄ of the collimator lenses 2₁˜2₄ are made parallel to the optical axis of the optical system of the scanning apparatus. Further, the optical axes 12₁˜12₄ of the light sources 1₁˜1₄ are shifted by the distances d₁˜d₄ from the optical axes13₁˜13₄ of the collimator lenses 2₁˜2₄.

In FIG. 4, the light beams 5₁ is shown by its center and its bean radius 51₁, although the light beams 5₂˜5₄ are shown only by their centers. The incident positions of the light beams 2₁˜2₄ to the cylindrical lens 4 may be symmetrical regarding the optical axis 6 of the optical system, or arbitrary positions corresponding to the first reflecting mirrors 9₁˜9₄. The incident angles θ₁˜θ₄ may be symmetrical regarding the optical axis 6 of the optical system, or arbitrary angles corresponding to the first reflecting mirrors 9₁˜9₄.

For example, the parallel light beam 5₁₁ has the incident angle θ₁, because its optical axis 12₁ is shifted by the distance d₁ from the optical axis 13₁.

Therefore, the light beams 5₁˜5₄ are incident to the reflecting surface 7₄ with prescribed pitches. Therefore, the reflected light beams 5₁˜5₄.

Spread away from the optical axis 6, without using any special scanning lens.

Accordingly, the light beams are sufficiently separated with each other, without employing such measures as elongation of the distance between the scanning mirror and the separation mirror, the optical power increase in the scanning lens, or enlargement of the cylindrical lens along the sub-scannning direction. Thus, the image forming apparatus becomes simpler and cheaper with fewer components, because it is not needless to make the apparatus large-sized, to employ any method which possibly induces defects, to cost up the production of the apparatus, or to design any difficult jig.

Further, the scanning apparatus of the present invention is explained in more detail, referring to FIG. 3 and FIG. 4. The incident angles θ₁˜θ₄, the shift distances d₁˜d₄ and the focal distances Fcl₁˜Fcl₄ of the collimator lens f₁˜f₄ are related by the following formula (1).
tan θᵢ=di/Fcl₁ where i=1˜4 (1)

Further, the incident angles θ₁˜θ₄, the height of the reflection points (the distances from the optical axis 6) on the reflection surface 7₁ of the rotational polygon mirror 7 and the focal distance Fcy of the cylindrical lens 4 are related by the following formula (2).
tan θᵢ=hi/Fcy₁ where i=1˜4 (2)

Therefore, the following formula (3) holds.
di·Fcyᵢ=hi·Fclᵢ where i=1˜4 (3)

Further, the output angles δ₁˜δ₄, after exiting the cylindrical lens 4, which are angles from the optical axis 6; the heights A₁˜A₄ of the incident points (the distances from the optical axis 6) are related by the following formula (4).
tan δᵢ=(Ai+hi)/Fcyᵢ where i=1˜4 (4)

Therefore, by using the distances L₁˜L₄ between the reflecting surface 7₁ and the first reflecting mirrors 9₁˜9₄, the reflection heights (the distances from the optical axis 6) at the first reflecting mirrors 9₁˜9₄ are expressed by the following formula (5).
Li·tan δᵢ+hi where i=1˜4 (5)

Further, the height difference D12 between the reflecting mirror9₁ and the reflecting mirror 9₂ is expressed by the following formula (6).
D12=(L₁·tan δ₁+h₁)−(L₂·tan δ₂+h₂) (6)
where i=1˜4

Further, formula (6) is rewritten by using formula(3) and (4), thereby obtaining formula (7).

$$D 12 = ( {L}_{1} \cdot {A}_{1} - {L}_{2} \cdot {A}_{2} ) / Fcy + ( {L}_{1} \cdot {D}_{1} - {L}_{2} \cdot {D}_{2} ) / Fc 1 + ( {d}_{1} - {d}_{2} ) \cdot ( Fcy / Fc 1 ) \qquad ( 7 )$$

The height difference D12 may preferably be at least t3 mm, taking into consideration the beam radius and the curvature of the scanning line. Accordingly, inequity (8) holds.

$$D 12 = ( ( {L}_{1} \cdot {A}_{1} - {L}_{2} \cdot {A}_{2} ) / Fcy + ( {L}_{1} \cdot {D}_{1} - {L}_{2} \cdot {D}_{2} ) / Fc 1 + ( {d}_{1} - {d}_{2} ) \cdot Fcy / Fc 1 ≧ 3 \qquad ( 8 )$$

Further, the distance DST₁˜DST₄ between the optical axis 12₁˜12₄ and the optical axis 13₁˜13₄ is estimated. For example, it is estimated that DST₁ is 0.051 mm and DST₂ is 0.015 mm, the incident angles θ₁ and θ₂ to the cylindrical lens 4 are 0.24° and 0.07°.

Similarly in the conventional apparatus, the reflecting surface of 7₁ of the rotational polygonal mirror 7 is the back-focal plane of the cylindrical lens 4. Further, the scanning lens 8 is positioned in such a manner that the reflecting surface 7₁ is conjugate with the surface of the photoreceptor 11, in order to avoid the tilt effect of the reflecting surface 7₁.

Here, the light beams are traced from the cylindrical lens 4 to the photoreceptors.

As already explained for the light beam 5₁, in the optical system of the present invention, the light beams 5₁˜5₄ are refracted by the cylindrical lens 4. Then, they are crossed with each other between the cylindrical lens 4 and the reflecting surface 7₁ and are focused on the reflecting surface 7₁ with prescribed pitches along the sub-scanning direction. Then, they proceed go away from the optical axis 6, are incident to the scanning lens 8 and then, reach the first reflecting mirror 9₁˜9₄.

Then, only the light beam 9₄ is directly directed onto the photoreceptor 9₄, while the light beams 9₁˜9₃ are reflected by the second reflecting mirrors 10₁˜10₃ and then, 10₁˜10₃ scan the photoreceptors 11₁˜11₃.

Thus, the incident angles θ₁˜θ₄ to the cylindrical lens4 is determined by the incident height to the reflecting surface 7₁ of the rotating polygonal mirror 7. Therefore, the incident height is determined in such a manner that the incident conditions are satisfied.

The cylindrical lens 4 may be of: the first surface curvature R1/(79.293); the second surface curvature/∞ (plane); maximum thickness D/3; refraction index Nd/(1.5168); Abbe number υ/(64.1); back focus BF/(100). Further, in FIG. 2, the incident position of the light beam 5₁ to the cylindrical lens 4 may be 10.44 mm from the optical axis 6, the incident angle θ₁ being 0.55°. The incident position of the light beam 5₂ to the cylindrical lens 4 may be 3.50 mmfrom the optical axis 6, the incident angle θ₂ being 0.185°. The incident position of the light beam 5₃ to the cylindrical lens 4 may be −3.50 mm from the optical axis 6, the incident angle θ₃ being −0.185°. The incident position of the light beam 5₄ to the cylindrical lens 4 may be −10.44 mm from the optical axis 6, the incident angle θ₄ being −0.55°. In this case, the reflecting mirror 9₁˜9₄ is positioned at 90 mm, 140 mm, 170 mm and 220 mm, respectively from the reflecting surface 7₁.

In the image forming apparatus of the present invention, the light beams are modulated by the image signals from the not shown control apparatus, corresponding to Y, C, M, K. The light beams are made parallel by the collimator lenses, are incident to the cylindrical lens, are focused on the reflecting surface of the polygonal mirror, are deflected by the rotational polygonal mirror and scan the photoreceptors at about constant speed.

AS already explained, when the light beams go out of the first reflecting mirror, reach the first reflecting mirror, only the light beam 9₄ is directly directed onto the photoreceptor 9₄, while the light beams 9₁˜9₃ are reflected by the second reflecting mirrors 10₁˜10₃ and then, 10₁˜10₃ scan the photoreceptors 11₁˜11₃, thereby forming the electrostatic latent images.

Then, the electrostatic latent images are developed by Y, C, M, K toners by the not-shown development apparatus. The toner images are transferred in the overlapped manner on the paper, thereby outputting the full color image.

As explained above, the optical arrangement of the present invention of the light beams, the collimator lenses and the cylindrical lenses makes the different incident points, which are sufficiently separated, on the rotational polygonal mirror along the sub-scanning direction. Therefore, after deflected by the scanning mirror, the light beams widely spread from the optical axis of the optical system of the present invention, without employing any special scanning lens of great optical power.

Also as explained above, the light beams are sufficiently separated with each other, without employing such measures as elongation of the distance between the scanning mirror and the separation mirror, the optical power increase in the scanning lens, or enlargement of the cylindrical lens along the sub-scanning direction. Thus, the image forming apparatus becomes simpler and cheaper with fewer components, because it is not needless to make the apparatus large-sized, to employ any method which possibly induces defects, to cost up the production of the apparatus, or to design any difficult jig.

What is claimed is:

1. An electrostatic color image forming apparatus wherein a single rotational polygonal mirror scans a plurality of light beams for exposing the plurality of photoreceptors, which comprises:
collimator lenses for making said light beams parallel; and
an intermediate lens, positioned between said collimator lenses and said rotational polygonal mirror, for focusing said light beams on a reflecting surface of said rotating polygonal mirror,
wherein:
optical axes of light sources of said light beams are parallel to axes of said collimator lenses;
said optical axes of light sources of said light beams are separated by prescribed pitches from said axes of said collimator lenses;
said light beams are incident to said intermediate lens at different incident positions along sub-scanning directions of said photoreceptors; and
said light beams are incident to said intermediate lens at different angles.

2. The electro-photographic color image forming apparatus, according to claim 1, wherein said incident angles are greater as said incident positions are more separated from said optical axes of said intermediate lens.

3. The electro-photographic color image forming apparatus, according to claim 1, which further comprises one or more scanning lenses for focusing on said photoreceptors said light beams deflected by said rotational polygon mirror and for scanning on said photoreceptors at constant speed on said photoreceptors along main-scanning directions of said photoreceptors.

4. The electro-photographic color image forming apparatus, according to claim 1, wherein said light beams expose said photoreceptors allocated to electrostatic latent images of yellow, cyan, magenta and black.

5. The electro-photographic color image forming apparatus, according to claim 1, wherein said intermediate lens is a single cylindrical lens.
